(19) United States
(12) Patent Application Publication
(10) Pub. No.: US 2026/0187933 A1
(43) Pub. Date: Jul. 2, 2026

(54) SELF-TRAINING OBJECT PERCEPTION SYSTEM

(71) Applicant: Georgia Tech Research Corporation, Atlanta, GA (US)

(72) Inventor: Benjamin Peter Joffe, Atlanta, GA (US)

(21) Appl. No.: 19/131,150

(22) PCT Filed: Nov. 21, 2023
(86) PCT No.: PCT/US2023/080820

§ 371 Date: May 19, 2025

Related U.S. Application Data
(60) Provisional application No. 63/427,004, filed on Nov. 21, 2022.

(51) Int. Cl. G06T 17/20; G06F 3/0346; G06F 3/04815; G06N 20/00; G06V 10/774

(52) U.S. Cl. CPC G06T 17/20; G06F 3/0346; G06F 3/04815; G06N 20/00; G06V 10/774

(57) ABSTRACT

A self-training object perception system that generates a general-purpose object descriptor of a three-dimensional target object (a canonical mesh model and a single machine learning model) that can be used to generate predictions for manipulating the target object. The system eliminates the need to collect real data or ground truth annotation (for example, by automatically generating the training data used to train the machine learning model), enabling users to generate a general-purpose object descriptor for any target object with minimal labor input (e.g., in minutes).

### CROSS-REFERENCE TO RELATED APPLICATIONS

This application claims priority to U.S. Prov. Pat. Appl. No. 63/427,004, filed Nov. 21, 2022, which is hereby incorporated by reference.

### FEDERAL FUNDING

None

### BACKGROUND

In robotic object manipulation, it often desirable pick a target object and place that object in a target location (in some instances, with a target orientation), pick a target object from a bin of nearly identical objects (e.g., bin picking), pick a target object by a specific part of the target object, etc. To do so, it is often necessary to predict the 6D pose of the target object (i.e., the three-dimensional position and three-dimensional orientation of the target object in three-dimensional space) using captured image data.

Existing object perception methods commonly require separate machine learning models for making object perception predictions for each separate robotics task. To effectively train each additional machine learning model to perform each additional task, training data must be identified (for example, thousands of annotated images of the object to be perceived in various environments).

Accordingly, there is a need for an object perception system that can be trained to perceive an additional object with minimal manual input (i.e., without the collection of real data or ground truth annotation).

### SUMMARY

A self-training object perception system that generates a general-purpose object descriptor of a three-dimensional target object (including a canonical mesh model of the target object and a single machine learning model) that can be used to generate predictions for manipulating the target object. The system eliminates the need to collect real data or ground truth annotation (for example, by automatically generating the training data used to train the machine learning model), enabling users to generate a general-purpose object descriptor for any target object with minimal labor input (e.g., in minutes).

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram of an architecture 100 for a self-training object perception system according to exemplary embodiments.

FIG. 2 is a block diagram of the self-training object perception system according to exemplary embodiments.

FIG. 3A is a flowchart of a process for generating a canonical mesh model according to an exemplary embodiment.

FIG. 3B is an example view of a graphical user interface according to exemplary embodiments.

FIG. 4A is a flowchart illustrating a process for generating training data according to an exemplary embodiment.

FIG. 4B includes example images generated using the process illustrated in FIG. 4A.

FIG. 5 is a block diagram of the self-training object perception system according to other exemplary embodiments.

### DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

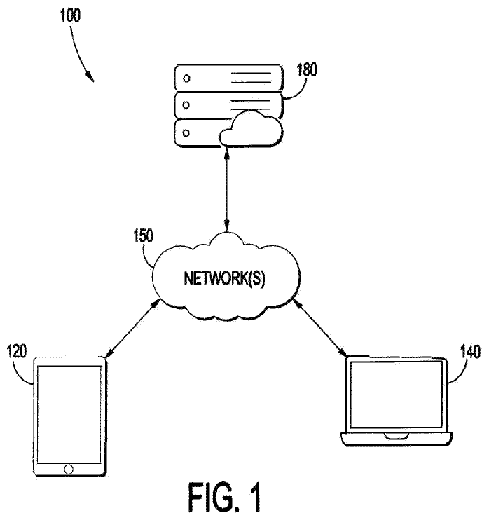

FIG. 1 is a diagram of an architecture 100 for a self-training object perception system according to exemplary embodiments.

In the embodiment of FIG. 1, the architecture includes a server 180 in communication with a smartphone 120 (and, in some embodiments, a personal computer 140) via one or more computer networks 150 (e.g., the Internet). The server 180 includes non-transitory computer readable storage media suitably configured to store data and computer readable instructions. The server 180 also includes one or more hardware computer processors suitably configured to execute those instructions to perform the functions described herein.

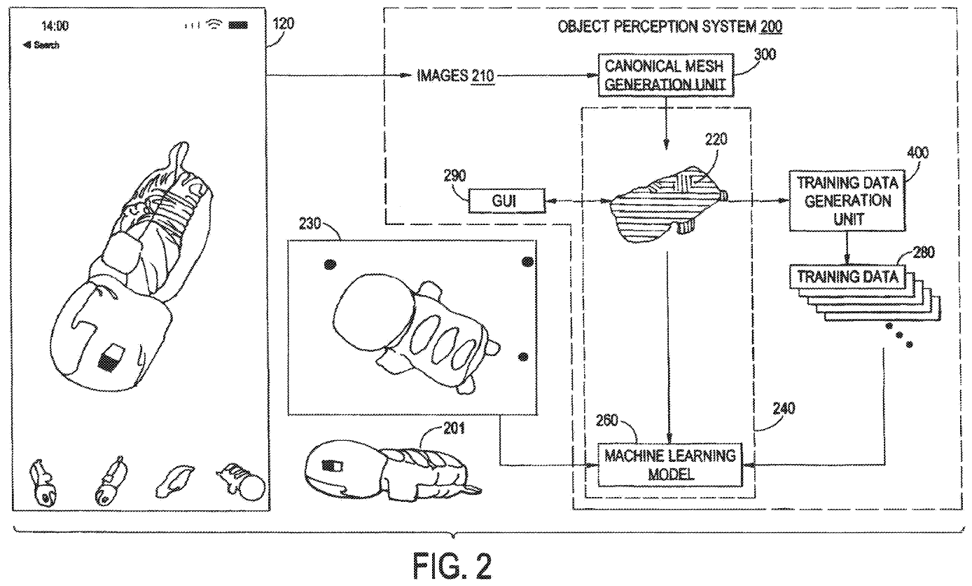

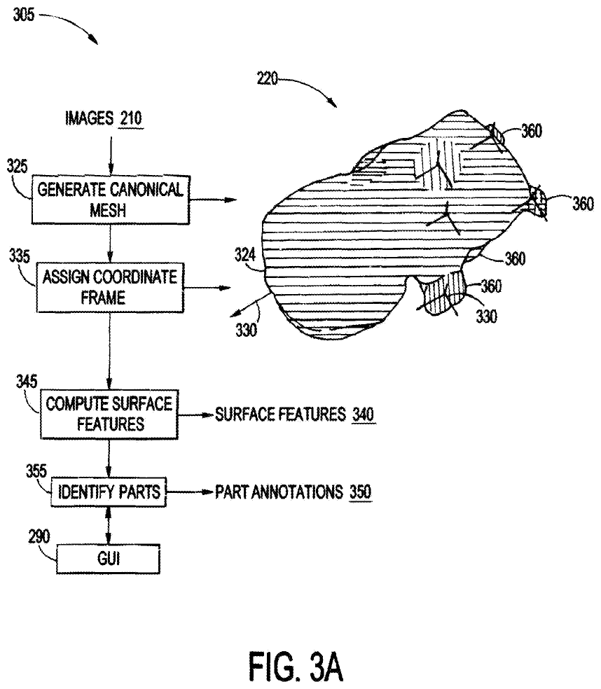

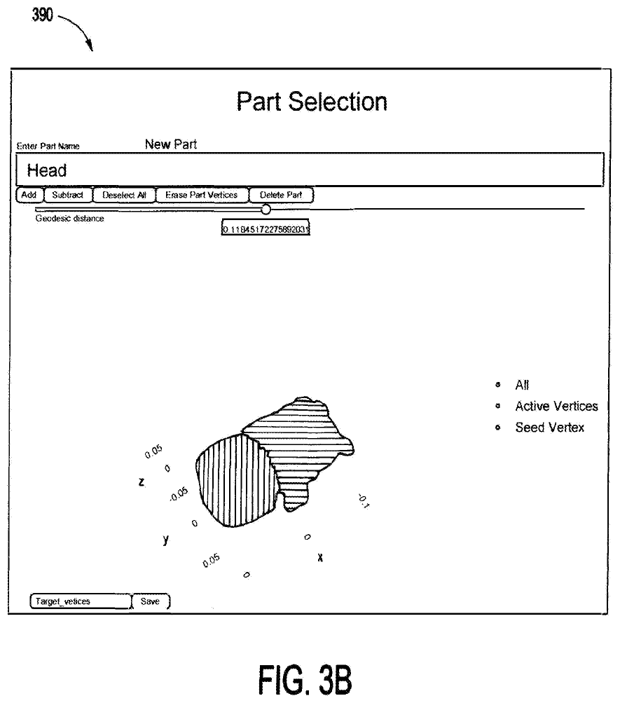

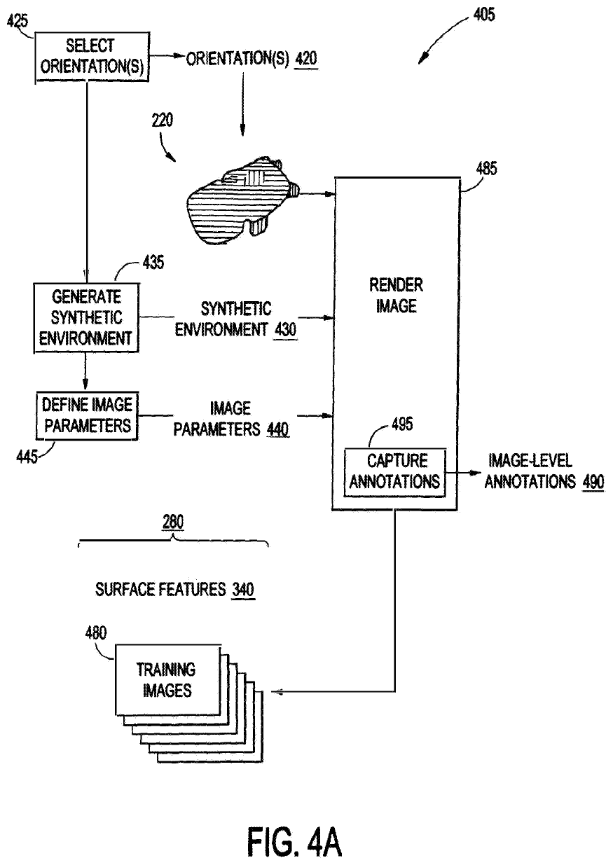

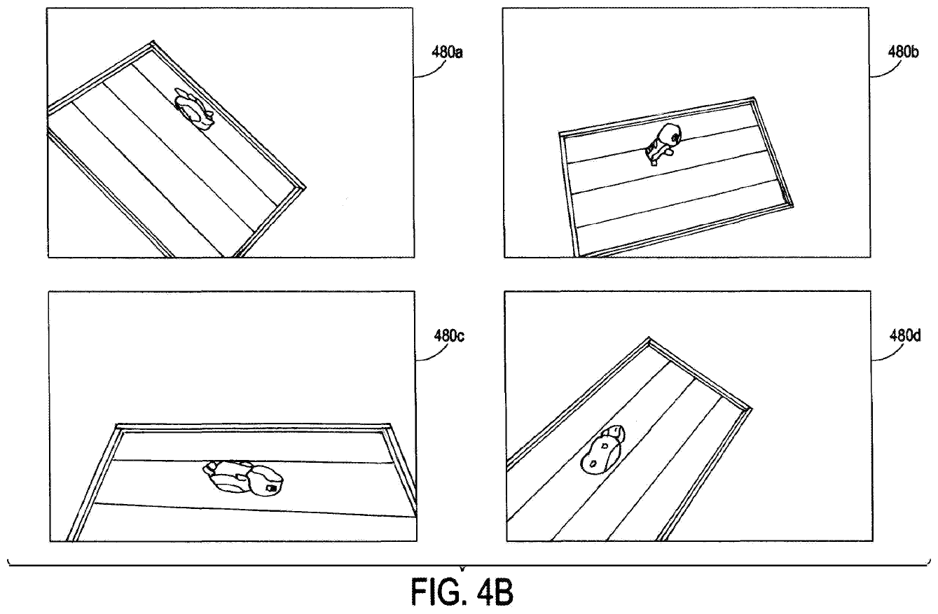

FIG. 2 is a block diagram of the self-training object perception system 200 according to exemplary embodiments. In the embodiment of FIG. 2, the system 200 includes a canonical mesh generation unit 300 (described in detail below with reference to FIG. 3A), a training data generation unit 400 (described in detail below with reference to FIG. 4A), a machine learning model 260 (e.g., a neural network), and a graphical user interface 290 (accessible, for example, via the smartphone 120 or the personal computer 140). The canonical mesh generation unit 300, the training data generation unit 400, the machine learning model 260, and the graphical user interface 290 may be realized as software instructions stored and executed by the server 180 (or the personal computer 140). The graphical user interface 290 may be accessible via the personal computer 140 or the smartphone 120.

As shown in FIG. 2, the system 200 trains the machine learning model 260 to recognize a target object 201 and the 6D pose of the target object 201 in captured image data 230. To do so, the canonical mesh generation unit 300 generates a three-dimensional canonical mesh model 220 of a target object 201 and the machine learning model 260 is trained to map pixels in the captured image data 230 of the target object 201 to the generated canonical mesh model 220. The canonical mesh generation unit 300 generates the canonical mesh model 220 using images 210 of each surface of the target object 201 (e.g., captured using a photogrammetry application installed on the smartphone 120 as the target object 201 is hung by a wire or fishing line). In some embodiments, the system 200 also provides functionality via the graphical user interface 290 for a user to identify parts of the generated canonical mesh model 220 that belong to individual, articulatable parts of the target object 201.

The machine learning model 260 is trained using training data 280 to map the pixels in the captured image data 230 of the target object 201 to the generated canonical mesh model 220. The canonical mesh model 220 and the machine learning model 260 form a general-purpose object descriptor 240 that can be deployed (e.g., transferred to and used by a robotic object manipulation system in a warehouse environment) for robotic perception of the target object 201 (e.g., to pick the target object 201 from a bin, to pick the target object 201 up by a specific part, to place the target object 201 in a target location with a target orientation, etc.). Critically, training data generation unit 400 generates the training data 280 without requiring the user to collect real data or provide ground truth annotation. Accordingly, the system 200 trains the machine learning model 260 to perceive the target object 201 with minimal input from a user.

FIG. 3A is a flowchart of a process 305 for generating the canonical mesh model 220 according to an exemplary embodiment.

As shown in FIG. 3A, the three-dimensional canonical mesh model 220 of the target object 201, including a number of vertices 324 in a three-dimensional space defined by a coordinate frame, is generated using the images 210 of the target object 201 in step 325. For example, the canonical mesh generation unit 300 may use “structure-from-motion” photogrammetry to reconstruct the three-dimensional geometry and color of the target object 201 based on multiple views of the target object 201 in the captured images 210 and the relative movement of the smartphone 120 between capturing of each image 210. (See, e.g., Schonberger, Johannes L., and Jan-Michael Frahm. “Structure-from-motion revisited.” Proceedings of the IEEE conference on computer vision and pattern recognition, pp. 4104-4113. 2016)

A coordinate frame 330 of the target object 201 is assigned in step 335. Because the 6D poses of the target object 201 are predicted as a relative transformation of the coordinate frame 330 of the target object 201, the origin and orientation of the assigned coordinate frame 330 can be arbitrary (as long as it is fixed in space). For instance, the canonical mesh generation unit 300 may assign the origin of the coordinate frame 330 to the geometric center of the target object 201. The initial orientation of the coordinate frame 330 may be similarly arbitrary. In various embodiments, the orientation of the coordinate frame 330 may be initially selected to match the orientation of the camera frame in the first image frame of the scanned images 210, to align with the longest dimension of the target object 201 (and the longest dimension of the target object 201 in an orthogonal direction), etc. Meanwhile, as briefly mentioned above and described below with reference to FIG. 3B, the graphical interface 290 may provide functionality for the user to rotate the coordinate frame 330 initially identified by the canonical mesh generation unit 300.

In the embodiments of FIG. 3A, surface features 340 for each vertex 324 of the generated canonical mesh model 220 are calculated in step 345. For each vertex 324 in the canonical mesh model 220, for example, the canonical mesh generation unit 300 may pre-compute 256 features (also referred to as embeddings) indicative of the geometric features around each vertex 324, including the decomposed surface features at each vertex 324 of the canonical mesh model 220 (e.g., using the Laplace-Beltrami operator), the pairwise geodesic distances between each pair of vertices 324, a summary of each vertex 324, etc.

FIG. 3B is example view 390 of the graphical user interface 290 according to exemplary embodiments.

As shown in FIG. 3B, the user interface 290 may provide functionality to identify vertices 324 of the canonical mesh model 220 as belonging to individual, articulable parts 360 of the target object 201 (i.e., part annotations 350) in step 355. For example, the interface 290 may provide functionality for the user to select a seed vertex 324 and a threshold distance (e.g., a geodesic threshold distance) within which to assign each vertex 324 of the canonical mesh model 220 to an individual part 360. In those instances, the canonical mesh generation unit 300 may identify a coordinate frame 330 for each individual part 360 and provide functionality for the user to rotate each generated coordinate frame 330.

FIG. 4A is a flowchart illustrating a process 405 for generating the training data 280 according to an exemplary embodiment. To generate the training data 280 used to train the machine learning model 260, the training data generation unit 400 generates a dataset of training images 480 (e.g., 10,000 images) of the target object 201 in photorealistic scenes. FIG. 4B shows example training images 480a, 480b, 480c, and 480d generated using the process 405.

As shown in FIG. 4A, an orientation 420 of the target object 201 is arbitrarily selected in step 425, a synthetic environment 430 (e.g., a warehouse) is selected in step 435, and image parameters 440 (e.g., a camera position, lighting, physics, etc.) are arbitrarily selected in step 445. In embodiments where the target object 201 includes articulatable parts 360, an orientation of each articulatable part 360 may be randomly selected. The orientation(s) 420, the synthetic environment 430, and the image parameters 440 may be randomly selected, for example, using a python script.

Training images 480 (having the arbitrarily selected image parameters 440) of the target object 201 in the synthetic environment 430 and having the arbitrarily selected orientation 420 are then rendered in step 485. To render each training image 480, the synthetic environment 430 (including the target object 201 in the selected orientation 420) is rendered three dimensionally and a two-dimensional image is projected onto a two-dimensional plane (as dictated by the image parameters 440).

For each of the generated training images 480, image-level annotations 490 are captured in step 495. For example, raycasting may be used to map each pixel in the generated training image 480 to the corresponding vertex 324 of the canonical mesh model 330. The image-level annotations 490 may include, for example, two-dimensional keypoints identified in the training image 480, a vertex 324 of the canonical mesh model corresponding to each identified two-dimensional keypoint, bounding boxes that surround the portions of the training image 480 that include the object 201, segmentation masks indicating whether each pixel (within the bounding box) is image data captured from the target object 201 (or the background behind the target object 201).

The process 405 is performed repeatedly (e.g., 10,000 times) to generate training images 480 of the target object 201 (and image-level annotations 490) as the 6D pose of the target object 201 and the simulated three-dimensional environments 430 are arbitrarily transformed and manipulated.

Because the training data generation unit 400 can generate photorealistic training data 280 for any target object 201 scanned by the user, the machine learning model 260 can be trained to make predictions for any target object 201 scanned by the user. To train the machine learning model 260 to distinguish between the target object 201 and nearly identical objects (e.g., so as to pick the target object 201 out of a bin), the training data generation unit 400 can generate images 480 of the target object 201 in simulated three-dimensional environments 430 that include other identically-sized objects and identify segmentation masks to distinguish between image data of the target object 201 and image data of the other objects.

Referring back to FIG. 2, the machine learning model 260 is trained using the training data 280 to predict each vertex 324 in the canonical mesh model 220 that most likely corresponds to each pixel in received image data 230. For example, the machine learning model 260 is trained to predict a high-dimensional embedding (e.g., a 256-dimensional embedding) for each pixel in the captured image data 230 and compare those predicted embeddings to the surface features 340 pre-computed for each vertex 324 in the canonical mesh model 220 (e.g., Euclidean distance between the predicted embedding of each pixel and the pre-computed embeddings for each vertex 324 in the canonical mesh model 220). Rather than individually mapping each pixel in the image data 210 to one vertex 324 of the canonical mesh model 220, the system 200 gets robust correspondences by using all high-scoring vertex predictions for each pixel and performs outlier filtering and smoothing. By identifying the vertices 324 having surface features 340 that most likely correspond to each pixel, the machine learning model 260 is trained to identify the vertices 324 that most likely correspond to each pixel. The pose of each individual part 360 of the target object 201 may be similarly computed by extracting pixels with high-scoring vertices 324 belonging to each individual part 360.

Once the machine learning model 260 is trained using the training data 280, the canonical mesh model 220 and the machine learning model 260 form a general purpose object descriptor 240 that can be deployed (e.g., transferred to and used by a robotic object manipulation system in a warehouse environment) to detect the target object 201 in captured image data 230 (e.g., to identify a bounding box surrounding the portion of the captured image data 230 that includes the target object 201 and identify a segmentation mask identifying the image data 230 within the bounding box that includes the target object 201) and to predict the 6D pose of the target object 201.

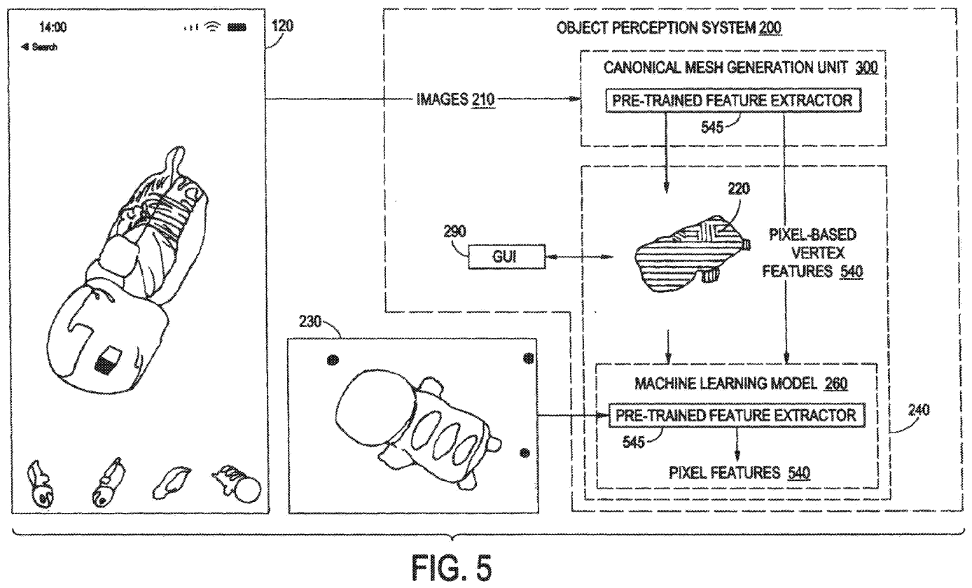

FIG. 5 is a block diagram of the self-training object perception system 200 according to other exemplary embodiments. The embodiments of FIG. 5 are similar to the embodiments described above with reference to FIGS. 2-4. However, instead of computing surface features 340, the canonical mesh generation unit 300 includes a pre-trained feature extractor 545 (e.g., a foundation model) that extracts pixel-level features 540 from the source images 210 for each vertex 324 of the canonical mesh model 220. Because the canonical mesh model 220 is built from a collection of images 210 of the target object 201, each vertex 324 in the canonical mesh model 220 has at least one corresponding pixel in at least one of the images 210 used to build the canonical mesh model 220. If a vertex 324 has multiple correspondences (e.g., multiple views of the same point on the target object 201), the mean of the pixel-level features 540 may be used.

In the embodiments of FIG. 5, the machine learning model 260 includes the same pre-trained feature extractor 545, which identifies pixel features 540 for each pixel in the captured image data 230. Similar to the embodiment of FIG. 2, the machine learning model 260 predicts the vertex 324 that most likely corresponds to each pixel in the captured image data 230. However, in the embodiment of FIG. 5, the machine learning model 260 is constructed to do so by identifying the vertex 324 having the pixel-based vertex features 540 that most likely correspond to the pixel features 540 extracted for that pixel. Accordingly, in the embodiment of FIG. 5, the machine learning model 260 can be used for an arbitrary object without generating training image data 480, as long as its pre-trained feature extractor 545 matches that in the canonical mesh generation unit 300.

In addition to predicting 6D poses of parts 360, the general-purpose object descriptor 240 can also be used to identify a semantic point (or group of points) on an image 230 of an object 201 based on a selected semantic vertex 324 in a canonical mesh model 220 of the object's category. For example, a user can select vertices 324 corresponding to eyes in the canonical mesh model 220 of a plush toy category (using the graphical user interface 290 as described above) and the model 260 will be able to identify eyes on arbitrary images of plush toys without new data or training of the ML model 260 to perform that new task. Only the canonical model 220 needs to be updated with a new annotation.

The self-training object perception system 200 has a number of advantages over existing object perception methods. The self-training object perception system 200 generates a general-purpose 3D object descriptor model 240 of the target object 201 with minimal labor input (e.g., in minutes) that can be used for all perception tasks. Additionally, the self-training object perception system 200 uses a single machine learning model 260 for any geometric input, which trained without the need to collect real data or ground truth annotation.

To predict the 6D pose of an object, a 6D pose of its part, or a 3D grasping point on the surface of the object based on two-dimensional image data, prior art methods require the training of separate models for each of those task. By contrast, by training a machine learning model 260 to predict the vertices 324 in the canonical mesh model 220 that most likely correspond to each of the pixels in the captured image data 230, the system 200 enables both recognition of the target object 201 and prediction of an arbitrary set of 3D points and 6D poses corresponding to the target object 201 or its parts using only one object descriptor model 240. Additionally, unlike existing systems for identifying 6D poses of target objects 201, the self-training object perception system 200 is not limited to rigid objects. Instead, because the self-training object perception system 200 makes pointwise predictions, the system 200 can be used to perceive deformable objects as long as the deformable target object 201 has some identifiable features.

Because the self-training object perception system 200 separately identifies each part 360 of the target object 201, the self-training object perception system 200 is not limited to rigid objects and can be used to identify the 6D pose of each detected part of a target object 201 with articulatable parts 360. The self-training object perception system 200 can also predict the coordinates of parts 360 of the target object 201 that are not visible in the image data 230.

The object descriptor model 240 can also be used to approximate the depth of the target object 201 using only two-dimensional data, eliminating the need to capture depth information (e.g., using an RGB-Depth camera, LiDAR, capturing multiple two-dimensional images and triangulating the source of each pixel, etc.). Instead, the depth of the target object 201 can be approximated based on scale of pixels that correspond to the vertices of the canonical mesh model.

Finally, because the predicted 6D pose of the target object 201 (and other predictions) are based on discrete points, the self-training object perception system enables users to analyze which points are misidentified (if any). Accordingly, in contract to other machine learning-enabled perception methods, the results are explainable.

While preferred embodiments have been described above, those skilled in the art who have reviewed the present disclosure will readily appreciate that other embodiments can be realized within the scope of the invention. Accordingly, the present invention should be construed as limited only by any appended claims.

1. A method, comprising:
receiving images of a target object;
generating a three-dimensional canonical mesh model of the target object based on the received images of the target object, the three-dimensional canonical mesh model including a number of vertices in a three-dimensional space defined by a coordinate frame;
for each vertex of the three-dimensional canonical mesh model, computing one or more surface features indicative of geometric features around each vertex, the one or more surface features for each vertex forming a pre-computed embedding for the vertex;
mapping the vertices of the three-dimensional canonical mesh model to two-dimensional keypoints in the received images corresponding to those vertices;
generating training data to train a machine learning model by rendering images of the target object in simulated three-dimensional environments;
capturing image data that includes the target object in a 6D pose; and
predicting the 6D pose of the target object, by the machine learning model, by predicting a high-dimensional embedding for each pixel in the captured image data, comparing the predicted embedding for each pixel in the captured image data to the to-pre-computed embedding for each vertex in the canonical mesh model, and predicting the vertex of the canonical mesh model that most likely corresponds to at least some of the pixels in the captured image data.

2. The method of claim 1, further comprising:
providing functionality, via a graphical user interface, for a user to identify a plurality of parts of the target object and the vertices of the canonical mesh model belonging to each of the plurality of parts of the target object.

3. The method of claim 2, wherein predicting the 6D pose of the target object comprises predicting the 6D pose of each part of the target object.

4. The method of claim 1, wherein images of the target object are generated by rendering the canonical mesh model and applying pixel values from the received images corresponding to each vertex of the canonical mesh model.

5. The method of claim 4, wherein rendering images of the target object in the simulated three-dimensional environments further comprises arbitrarily transforming the 6D pose of the target object in the simulated three-dimensional environments.

6. The method of claim 5, wherein rendering images of the target object in the simulated three-dimensional environments further comprises arbitrarily transforming simulated environmental objects, a simulated camera position, or simulated lighting.

7. A method, comprising:
receiving images of a target object;
generating a three-dimensional canonical mesh model of the target object based on the received images of the target object, the three-dimensional canonical mesh model including a number of vertices in a three-dimensional space defined by a coordinate frame;
for each vertex of the three-dimensional canonical mesh model, using a pre-trained feature extractor to extract pixel-level features from one or more pixels corresponding to the vertex;
capturing image data that includes the target object in a 6D pose;
using the pre-trained feature extractor to extract pixel-level features from each pixel in the captured image data; and
predicting the 6D pose of the target object, by a machine learning model, by predicting the vertex in the canonical mesh model having the pixel level features that most likely corresponds to the pixel-level features of each pixel in the captured image data.

8. The method of claim 7, wherein extracting pixel-level features corresponding to each vertex comprises averaging pixel-level features extracted from pixels from multiple images corresponding to the vertex.

9. The method of claim 7, further comprising:
providing functionality, via a graphical user interface, for a user to identify a plurality of parts of the target object and the vertices of the canonical mesh model belonging to each of the plurality of parts of the target object.

10. The method of claim 9, wherein predicting the 6D pose of the target object comprises predicting the 6D pose of each part of the target object.

11. A system, comprising:
a canonical mesh generation unit adapted to:
receive images of a target object; and
generate a three-dimensional canonical mesh model of the target object based on the received images of the target object, the three-dimensional canonical mesh model including a number of vertices in a three-dimensional space defined by a coordinate frame;
for each vertex of the three-dimensional canonical mesh model, compute one or more surface features indicative of geometric features around each vertex, the one or more surface features for each vertex forming a pre-computed embedding for the vertex; and
map the vertices of the three-dimensional canonical mesh model to two-dimensional keypoints in the received images corresponding to those vertices;
a training data generation unit adapted to generate training data to train a machine learning model by rendering images of the target object in simulated three-dimensional environments; and
a general-purpose object descriptor comprising the canonical mesh model of the target object and the machine learning model trained on the training data, the general-purpose object descriptor adapted to:
receive image data that includes the target object in a 6D pose; and
predict the 6D pose of the target object, by the machine learning model, by predicting a high-dimensional embedding for each pixel in the captured image data, comparing the predicted embedding for each pixel in the captured image data to the to pre-computed embedding for each vertex in the canonical mesh model, and predicting the vertex of the canonical mesh model that most likely corresponds to each pixel at least some of the pixels in the captured image data.

12. The system of claim 11, further comprising:
a graphical user interface that provides functionality for a user to identify a plurality of parts of the target object and the vertices of the canonical mesh model belonging to each of the plurality of parts of the target object.

13. The system of claim 12, wherein the general-purpose object descriptor predicts the 6D pose of the target object comprises predicting the 6D pose of each part of the target object.

14. The system of claim 11, wherein the training data generation unit generates images of the target object by rendering the canonical mesh model and applying pixel values from the received images corresponding to each vertex of the canonical mesh model.

15. The system of claim 14, wherein the training data generation unit renders images of the target object in the simulated three-dimensional environments by arbitrarily transforming the 6D pose of the target object in the simulated three-dimensional environments.

16. The system of claim 15, wherein the training data generation unit renders images of the target object in the simulated three-dimensional environments by arbitrarily transforming simulated environmental objects, a simulated camera position, or simulated lighting.

17. A system, comprising:
a canonical mesh generation unit adapted to:
receive images of a target object;
generate a three-dimensional canonical mesh model of the target object based on the received images of the target object, the three-dimensional canonical mesh model including a number of vertices in a three-dimensional space defined by a coordinate frame;
for each vertex of the three-dimensional canonical mesh model, using a pre-trained feature extractor to extract pixel-level features from one or more pixels corresponding to the vertex; and
a general-purpose object descriptor comprising the canonical mesh model of the target object and a machine learning model comprising the pre-trained feature extractor, the general-purpose object descriptor adapted to:
receive image data that includes the target object in a 6D pose;
use the pre-trained feature extractor to extract pixel-level features from each pixel in the captured image data; and
predict the 6D pose of the target object, by a machine learning model, by predicting the vertex in the canonical mesh model having the pixel level features that most likely corresponds to the pixel-level features of each pixel in the captured image data.

18. The system of claim 17, wherein the canonical mesh generation unit extracts pixel-level features corresponding to each vertex by averaging pixel-level features extracted from pixels from multiple images corresponding to the vertex.

19. The system of claim 17, further comprising:
a graphical user interface that provides functionality for a user to identify a plurality of parts of the target object and the vertices of the canonical mesh model belonging to each of the plurality of parts of the target object.

20. The system of claim 19, wherein the general-purpose object descriptor predicts the 6D pose of the target object comprises predicting the 6D pose of each part of the target object.
